(19) United States
(12) Patent Application Publication
(10) Pub. No.: US 2014/0310089 A1
(43) Pub. Date: Oct. 16, 2014

(54) Fuel Reward and Loyalty Space System and Method

(71) Applicants: John Cullen, Dallas, TX (US); Jim Leroux, Millersville, MD (US); Marshall Reavis, Lake Bluff, IL (US); Megan Wiersma, Barrington, IL (US)

(72) Inventors: John Cullen, Dallas, TX (US); Jim Leroux, Millersville, MD (US); Marshall Reavis, Lake Bluff, IL (US); Megan Wiersma, Barrington, IL (US)

(21) Appl. No.: 13/863,221

(22) Filed: Apr. 15, 2013

(51) Int. Cl. G06Q 30/02

(52) U.S. Cl. CPC G06Q 30/0233
USPC 705/14.33

(57) ABSTRACT

A fuel-based consumer reward and loyalty space system and method in which a consumer can earn points towards a reward card with a predetermined dollar balance to be used to purchase fuel at the gasoline brand of their choice. The merchant can set up predetermined categories, or no categories at all, in which to allow a consumer frequenting the merchant to earn loyalty points. The consumer uses a loyalty token at the register to identify themselves and earn points upon purchasing products, with the point value set by the merchant. The points earned from each purchase are added to the consumer's account, stored in a database. Points are aggregated in the consumer's account across all participating merchants. Once the consumer's points reach a predetermined amount, such as 2,550 points, the consumer is automatically awarded a reward card with a predetermined reward amount added to the card. If the consumer already has a reward card, the predetermined amount is automatically added to the existing reward card in real-time, without any action on the part of the consumer.

### BACKGROUND OF THE INVENTION

1. Field of the Invention

The present invention relates to a fuel reward and loyalty space system and method providing participating merchants with a points for dollars exchange program.

2. Description of the Prior Art

There are many reward and loyalty programs in use today in the marketplace, some offering miles, points, and coupons based on the customer's spending and qualifying purchases. These reward programs require users to actively redeem their miles or points and limit their use. The customer must purchase the qualifying products, redeem the points or miles they have earned, and then may only use the redemption on limited purchases or products. The consumer usually must do things that they do not routinely do, such as access their account to redeem the reward or purchase items they do not routinely purchase. They are also usually issued a reward with a company from whom they don't routinely purchase. Consumers need a reward program that allows more earn-side opportunities with greater freedom and flexibility and a program that automatically issues rewards with no added consumer action.

U.S. Pat. No. 7,618,318 discloses a method for operating a reward program including the steps of establishing a plurality of product categories and receiving an indication of selected ones of the product categories. The method further includes the step of tracking customer purchases in at least the selected categories and providing a reward to the customer based at least in part upon customer purchases in the selected categories. The reward in the '318 patent changes every cycle, depending on the consumer's purchases, and is awarded at the end of the cycle. The reward amount in the present disclosure is always a predetermined amount, which does not need to be calculated every given cycle, and is issued as it is earned. Patent '318 does not disclose a single rewards card for a specific fuel company chosen by the consumer, automatic point conversion to the predetermined reward amount, or automatic addition of value onto the rewards card at the time it is earned.

U.S. Pat. No. 8,123,125 discloses a combined in-store and fuel center point-of-sale system having a first point-of-sale system, having a checkout manager and one or more checkout terminals, and a second point-of-sale system, having a fuel center and one or more fuel pumps, in communication with each other and with one or more primary databases containing marketing data, consumer data, master sales data, discount data, and merchandise product data, for generating a fuel discount at the second point-of-sale system based on first purchasing activity at the first point-of-sale system and/or second purchasing activity at a second point-of-sale system. Patent '125 calculates multiple possible fuel discounts and applies the highest fuel discount available. The reward system and method of the present disclosure does not have multiple possible fuel discounts. There is only one reward amount and it is issued once the consumer reaches a predetermined point amount. Furthermore, the predetermined reward amount is issued as a rewards card, it is not issued as a discount at the pump. Patent '125 does not disclose a single rewards card for a specific fuel company chosen by the consumer, automatic point conversion, or automatic addition of value onto the rewards card.

U.S. Pat. No. 7,606,730 discloses a loyalty system that allows a consumer to accumulate general loyalty points from one or more merchants, and convert any desired subset of general points to loyalty dollars associated with a specific merchant. The method patent '730 includes the steps of converting at least a portion of general loyalty points to a first merchant value, saving that first merchant value into a first database, converting at least a portion of general loyalty points to a second merchant value, saving the second merchant value into a second database, redeeming the first merchant value at the first merchant to make a purchase, and determining if a reward or loyalty points are earned based on a comparison of promotion rules and data from the purchases. In the system and method of the present disclosure, redemption in the reward program occurs after a consumer has accrued the predetermined amount of points, not at the time of purchase, at which time the consumer is issued a reward card in a predetermined amount. Once the consumer has a reward card, the value of subsequent rewards is automatically added to the reward card once the predetermined point amount is reached, without any further action by the consumer. The rewards card is issued for a specific fuel company, predetermined by the customer. There is only one type of points and they are not converted to multiple merchant values. Patent '730 does not disclose a single rewards card for a specific fuel company, automatic point conversion, and automatic addition of value onto the rewards card.

The prior art to date does not disclose a method where the consumer chooses the fuel company of his choice in which to earn rewards, the method automatically converts points to a predetermined reward without any further action needed by the consumer, and adds the reward value to the reward card automatically as it is earned. None of the prior art can be combined in this way to suggest these necessary modifications. There is no teaching, suggestion, or motivation that would have enabled a person of ordinary skill in the art to modify any prior art system to incorporate one loyalty program and a rewards card where the consumer chooses the fuel company in which to earn rewards and where points are automatically converted to dollars and added to the rewards card automatically as the points are earned, without any action on the part of the consumer.

A primary object of the present invention is to eliminate the technological barriers, by leveraging new and existing reward products, to entry into the fuel-based consumer reward and loyalty space industry, which barriers have hampered entry since the inception of the industry.

It is another object of the present invention to provide a system that is inexpensive to deploy, that is not balky, and that is reliable, where consumer service issues are reduced by allowing real-time redemption of consumer rewards earned and presented.

It is a further object of the present invention to allow unlimited merchant participation and redemption that utilizes dollars-off rewards, instead of cents-off per gallon rewards.

It is yet a further object of the present invention to significantly improve consumer loyalty and drive true incrementality for the merchant.

It is yet a further object of the present invention to offer the consumer a way to defray or remove the cost of fuel by simply going about their everyday spending patterns.

It is yet a further object of the present invention to provide a stored value card that will allow for the rapid deployment of a nationwide redemption network across multiple non-affiliated gasoline brands where dollars off reward cards are used to build a robust redemption network.

It is yet a further object of the present invention to provide a universal stored value card that will allow for the rapid deployment of a nationwide redemption network across multiple non-affiliated gasoline brands where the same card can be used at non-affiliate brands regardless of major oil affiliation where dollars off reward cards are used to build a robust redemption network.

It is yet a further object of the present invention to provide a universal stored value card that will allow for the rapid deployment of a nationwide redemption network across multiple non-affiliated gasoline brands where the same card can be used at non-affiliate locations regardless of major oil affiliation, where card authorization is provided for the current value on the reward card without requiring a minimum authorization value, where dollars off reward cards are used to build a robust redemption network.

### SUMMARY OF THE INVENTION

The fuel-based consumer reward and loyalty space system and method of the present invention is a reward system in which a consumer may sign up for the fuel loyalty program and earns points towards a reward card with a predetermined dollar balance to be used to purchase fuel from the gasoline brand of their choice. The merchant can set up predetermined categories, or no categories at all, in which to allow a consumer frequenting the merchant to earn loyalty points or to use the merchant's existing loyalty currency in a method of exchange for fuel loyalty points. The consumer registers for the fuel loyalty program, designating the gasoline brand of their choice. The consumer scans their existing loyalty card or otherwise identifies himself/herself at the register and earns points upon purchasing products in the predetermined categories, with the value determined by the merchant. Points can be earned for each dollar spent or triggered for certain items purchased or categories purchased. The points earned from each purchase or other qualifying event are added to the consumer's account, and stored in a database. Once the consumer's points reach a predetermined amount, such as 2,550 points, the consumer is automatically awarded a reward card with a predetermined reward amount, such as $25, and the reward card, corresponding to the brand selected by the consumer at the time of registration, is sent to the consumer. If the consumer already has a reward card, the predetermined reward amount is automatically added to the existing reward card in real-time, without any action on the part of the consumer. The consumer adds points from a loyalty currency aggregator, such as Points.com, and can earn points across a variety of different merchants for different qualifying behaviors and all of these points are aggregated into a single consumer points account.

Smaller merchants, who may not have the capability to utilize the preceding system, may purchase codes, which represent different point values. These codes are flexible and merchants can place these codes on certificates, cards or scratch-off tickets or put them in an email or mobile message or the like. The merchants can then distribute them to consumers that satisfy a required performance chosen by the merchant. The consumer may then visit the FuelCircle website or the website of a loyalty currency aggregator, such as the Points.com website, log into their account, and enter the code they received from the merchant. The point value corresponding to the code is then added to the consumer's account, and stored in the FuelCircle database.

Merchants may also directly deposit points into an individual's account. The merchant sets the qualifying purchase or qualifying behavior that the consumer needs to perform in order to earn points. When the merchant determines that the consumer has performed the qualifying behavior, the merchant deposits points directly into the consumer's account via an advanced programming interface (API) or other connection to the FuelCircle system.

### BRIEF DESCRIPTION OF THE DRAWINGS

The systems, methods, and computer readable media for controlling display objects in accordance with this specification are further described with reference to the accompanying drawings in which:

FIG. 1 is a flow diagram of the member registration consumer portal function of an embodiment of the fuel reward and loyalty space system and method of the present invention.

FIG. 2 is a flow diagram of the member registration merchant customer service function of an embodiment of the fuel reward and loyalty space system of the present invention.

FIG. 3 is a flow diagram of the lost, stolen, damaged member reward card function of an embodiment of the fuel reward and loyalty space system and method of the present invention.

FIG. 4 is a flow diagram of the brand change function of an embodiment of the fuel reward and loyalty space system and method of the present invention.

FIG. 5 is a flow diagram of the non-point-of-sale integrated points exchange (FuelCircle) function of an embodiment of the fuel reward and loyalty space system and method of the present invention.

FIG. 6 is a flow diagram of the non-point-of-sale integrated points exchange (FuelCircle) prepay function of an embodiment of the fuel reward and loyalty space system and method of the present invention.

FIG. 7 is a flow diagram of the merchant operator on-board and management function of an embodiment of the fuel reward and loyalty space system and method of the present invention.

FIG. 8 is a flow diagram of the merchant/operator payment for reward card funding function of an embodiment of the fuel reward and loyalty space system and method of the present invention.

FIG. 9 is a flow diagram of the operator payment for points and codes issuance fees function of an embodiment of the fuel reward and loyalty space system and method of the present invention.

FIG. 10 is a flow diagram of the reward card fulfillment and initial valuation function of an embodiment of the fuel reward and loyalty space system and method of the present invention.

FIG. 11 is a flow diagram of the reward card subsequent valuation function of an embodiment of the fuel reward and loyalty space system and method of the present invention.

FIG. 12 is a flow diagram of the expiration points function of an embodiment of the fuel reward and loyalty space system and method of the present invention.

FIG. 13 is a flow diagram of the expiration reward card funds function of an embodiment of the fuel reward and loyalty space system and method of the present invention.

FIG. 14 is a flow diagram of a loyalty currency aggregator's, such as Points.com, member validation and posting request function of an embodiment of the fuel reward and loyalty space system and method of the present invention.

FIG. 15 is a flow diagram of the member points balance adjustment function of an embodiment of the fuel reward and loyalty space system and method of the present invention.

FIG. 16 is a flow diagram of the reward card fulfillment and initial valuation—max transaction exceeded function of an embodiment of the fuel reward and loyalty space system and method of the present invention.

FIG. 17 is a flow diagram of the reward card reload—max transaction exceeded function of an embodiment of the fuel reward and loyalty space system and method of the present invention.

FIG. 18 is a flow diagram of the reward card reload—max working balance exceeded function of an embodiment of the fuel reward and loyalty space system and method of the present invention.

FIG. 19 is a flow diagram of the direct deposit of FuelCircle points function of an embodiment of the fuel reward and loyalty space system and method of the present invention.

FIG. 20 is a flow diagram of the direct deposit of FuelCircle points prepay function of an embodiment of the fuel reward and loyalty space system and method of the present invention.

### DETAILED DESCRIPTION OF THE ILLUSTRATED EMBODIMENTS

The reward and loyalty space system of the present invention primarily comprises a user interface, merchant location, a point of sale or in-store system, a merchant database, and a fuel loyalty database. The consumer may earn points at the checkout terminal. Points are issued based on qualifying consumer behavior, typically a purchase of a specific product or a product in multiples, a combination of products or a qualifying dollar amount. In addition to physical checkout terminals, this same process applies to online checkouts from e-commerce websites. Other point earning opportunities may be connected to the form of payment, such as using a specific credit card, staying at a participating hotel chain or by the consumer performing a qualifying non-purchase behavior, such as test driving a certain vehicle. After purchasing products at the merchant location, the amount spent on qualifying purchases is sent from the point of sale system (POS) to the merchant database and then to the fuel loyalty database. Merchants with a POS system are in direct communication with the system of the present invention through their POS system or may be in direct communication with store headquarters, which then communicates with the system of the present invention. For merchants without a POS system, there are other methods to secure connectivity, via a payment processing machine or other stand-alone terminal using a web-based interface. The consumer can check and make changes to his/her account via the fuel loyalty website and can convert other loyalty card balances or codes into points via a non-POS integrated solution connected to the fuel loyalty database.

The Fuel Loyalty Processor is the central database which stores customer accounts, data records, and earned points information. The Fuel Loyalty Processor is connected to the Digital Value Gateway and submits transactions via the Digital Value Gateway to reload funds onto the FuelCircle Rewards Card. A computer based platform for performing the steps of the system and process described in the illustrated embodiment is furnished by applicants as the FuelCircle system.

A consumer with an existing, valid loyalty card or token may register with a particular merchant to participate in the fuel-based consumer reward and loyalty space system and method of the present invention. The consumer can register online at the FuelCircle website, www.fuelcircle.com. The consumer can register at a kiosk, if available at the participating operator location, which has a direct link to the FuelCircle database. The consumer can also register at the participating operator location via a link to the FuelCircle website or database. Upon entering the consumer's information, an account ID is assigned to the consumer and associated with the consumer's existing loyalty card or token. A short message service message (SMS) or email message is sent to the consumer providing the consumer with a FuelCircle account number and a link to complete the final registration activation step, which is the creation of a username, password, marketing preferences, acceptance of terms and conditions and the selection of their preferred gasoline brand in which to receive rewards. The consumer may then log into the reward and loyalty space website and associate other loyalty programs with their account. Alternatively, the merchant may mass register their loyalty program members by providing the FuelCircle Processor with existing loyalty account numbers and their corresponding consumer identifying information.

A consumer with no existing, valid loyalty card or token may register with a particular merchant to participate in the fuel-based consumer reward and loyalty space system and method of the present invention by completing a paper application in store and handing it to the cashier or registering at a kiosk, if available at the location, that has a direct link to the FuelCircle database. The reward card of the present invention prominently displays “FuelCircle” and the redemption merchant, i.e.: the gasoline brand, in a secondary position. The consumer may then log into the reward and loyalty space website to complete their registration and then immediately start earning points at the rewards issuer.

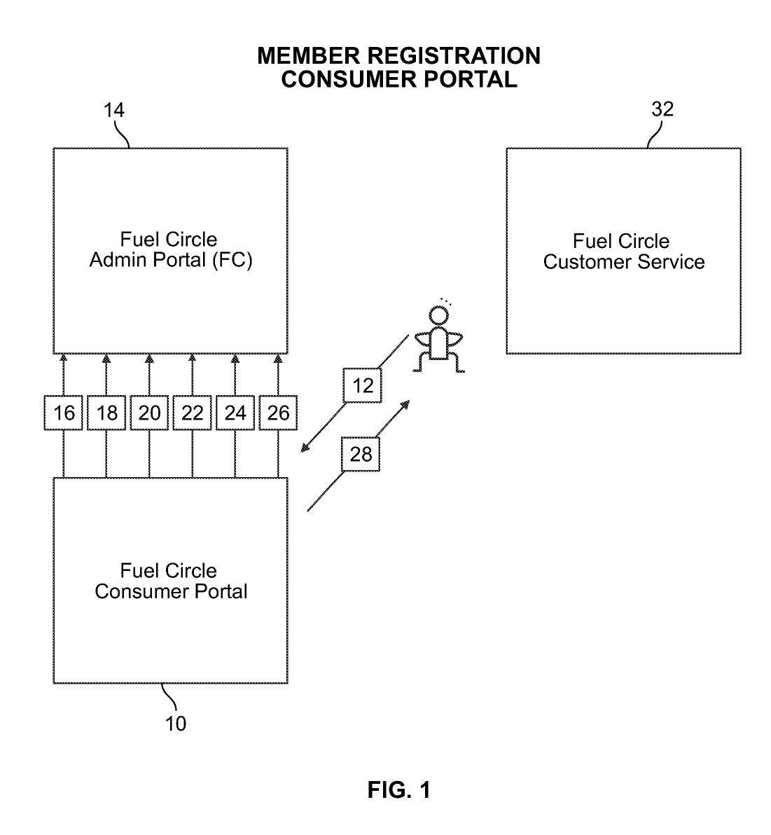

The consumer may also register online at the FuelCircle website/consumer portal 10, www.fuelcircle.com, shown in FIG. 1. The consumer portal 10 on the website displays all programs associated with the reward and loyalty space system of the present invention. After accessing the website, the consumer must log in, by entering the email address or phone number that was provided to the merchant, to complete registration. The consumer must submit additional identifying personal information 12, such as name, address, phone number, and email and must also choose the preferred oil brand in which to receive rewards. The consumer portal 10 then calls the FuelCircle Processing system 14 to create a new member number 16. The FuelCircle Processing system 14 returns the new member number, the FuelCircle Master ID (FCMID) 18. The consumer portal 10 calls the FuelCircle Processing system 14 a second time with a request to create a new loyalty card with the new FCMID 20 and the FuelCircle Processing system 14 returns a confirmation 22. The consumer portal 10 calls the FuelCircle Processing system 14 a third time with a request to set the brand for the account with the new FCMID 24 and FuelCircle Processing system 14 returns a confirmation 26. Upon receiving the FuelCircle Processing system's 14 confirmation of member creation, the consumer portal 10 sends a welcome/confirmation email, which requires no further action on the consumer's part, to the new member 28.

The consumer may also associate other loyalty programs with the reward and loyalty space of the present invention and may associate all loyalty cards of the present invention within a single household under a single parent account. Some merchants may want to host their own registration websites and then pass the registration data to the system via web services. This allows merchants to have their own branded websites and to integrate these sites to the FuelCircle processing system for providing consumers with their FuelCircle data such as points balances and points history. Thus, the merchant can retain more control over their customer's experience.

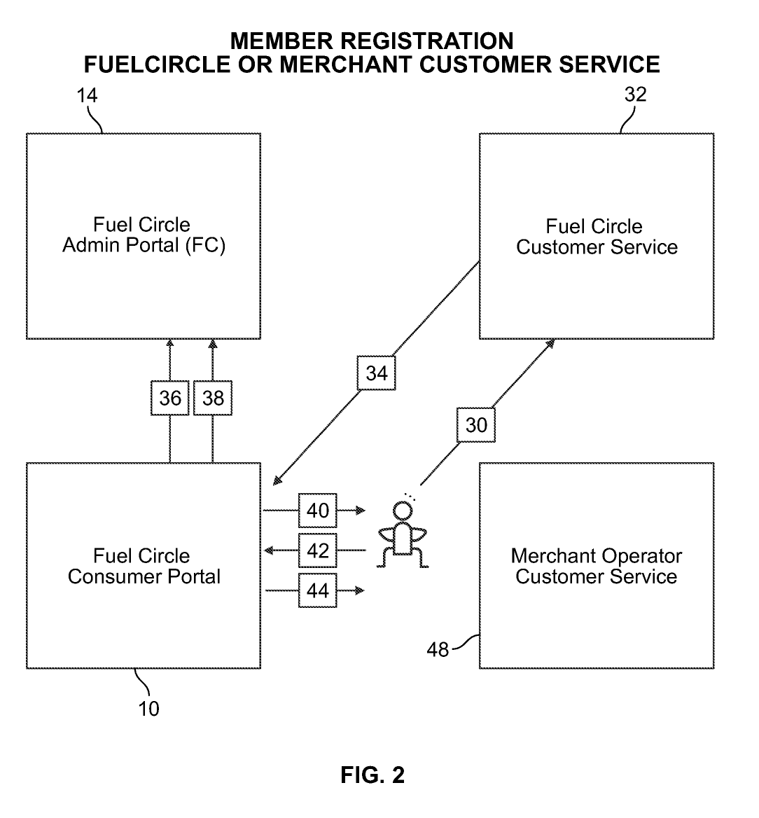

The consumer may also register and get assistance by calling, emailing, or faxing 30 FuelCircle customer service 32, shown in FIG. 2. FuelCircle customer service 32 logs into the consumer portal 10 registration page and enters all information 34, except password security question answers. The consumer portal 10 calls the FuelCircle Processing system 14 to create a new account, add the consumer, and add a loyalty card 36. The consumer portal 10 calls the FuelCircle Processing system 14 a second time to set the preferred brand 38. The consumer portal 10 then sends a follow up email to the new member with a temporary password and link to complete registration 40. The consumer follows the link to the consumer portal 10, answers security questions, sets a password, and accepts the terms and conditions 42. Once completed, the consumer portal 10 sends a welcome/confirmation email to the new member 44.

In addition to initial registration, the consumer portal 10 allows the consumer to view account activity, check the rewards card balance, update personal information, associate other loyalty programs, roll up rewards cards and accounts together under a parent account, and request replacement for lost, stolen, or damaged rewards cards. Fulfillment sends out cards and oversees reloads to existing cards. FuelCircle customer service is the call center.

The consumer can also update their name, address, phone number, email address, associated loyalty tokens, and can opt-in or opt-out of emails and SMS messages via the FuelCircle portal. When viewing account activity, the user can view the points earned and where they were earned, the points balance, and past points to funds conversions, and, in an alternate embodiment points expiration and dollars on rewards card expiration.

To request a replacement rewards card, the consumer fills out an online form which then generates a lost, stolen, or damaged email to FuelCircle customer service with the consumer's account ID and the reason for replacement. FuelCircle customer service receives the email and looks up the reward card number in the system. Customer service then checks the balance of the rewards card associated with the old brand and, if necessary, devalues the rewards card. FuelCircle enters a replacement order and picks, values, and ships the replacement rewards card associated with the new brand with the value taken from the old card added on. The system updates the rewards card number with the new card number in the consumers account and FuelCircle sends an email to the consumer advising that the replacement is complete.

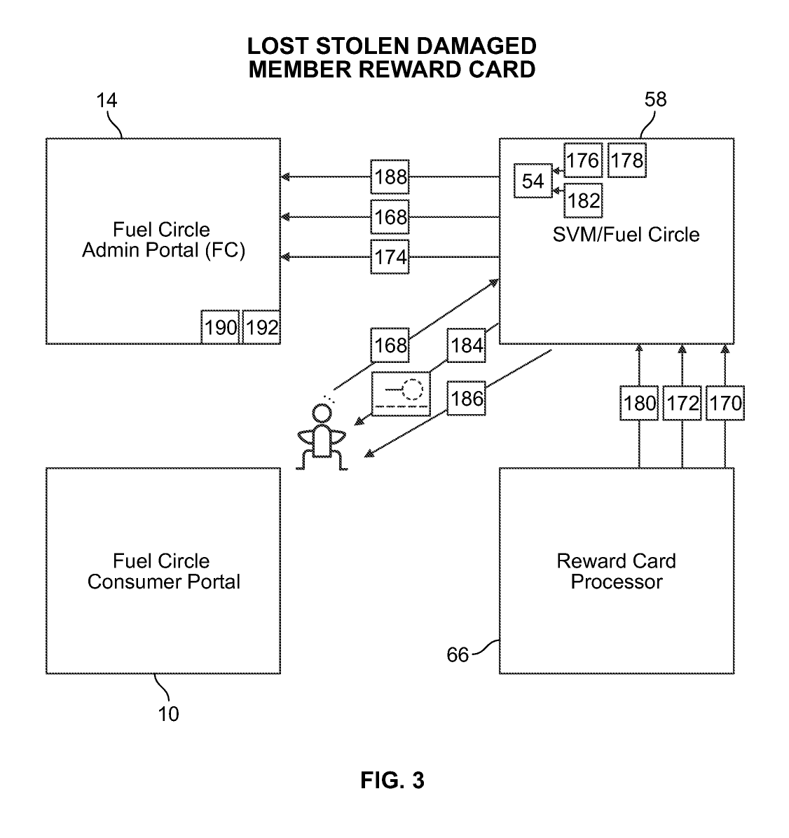

A flow diagram for reporting a lost, stolen, or damaged member reward card is shown in FIG. 3. Members can call or email to report a reward card lost, stolen, or damaged. If the member files a report via phone, FuelCircle customer service 32 verifies the member's identity by confirming their email address and responses to the security questions, through the FuelCircle Processing system 14. The FuelCircle customer service 32 verifies the reward card value 170 through Reward Card Processor 66 and devalues the reward card 172 through the Reward Card Processor 66, with the option of freezing the card. The FuelCircle customer service 32 then updates the member's reward card status in the FuelCircle Processing system 14 so funds will no longer be pushed to the reward card 174. FuelCircle customer service 32 enters a replacement order in its card fulfillment platform using FuelCircle Replacement “site” 176 and FuelCircle 58 Fulfillment QC's issues a replacement order 178. FuelCircle 58 Fulfillment activates the replacement reward card 180 through Reward Card Processor 66. FuelCircle fulfillment platform ships the replacement reward card to the member 184. FuelCircle fulfillment platform generates a shipment email to the member 186 and generates and pushes the tracking file to the FuelCircle Processing system 14 with all replaced reward card numbers 188. The FuelCircle Processing system 14 then adds the new reward card number 190 and changes the reward card status so funds can be pushed onto the new reward card 192.

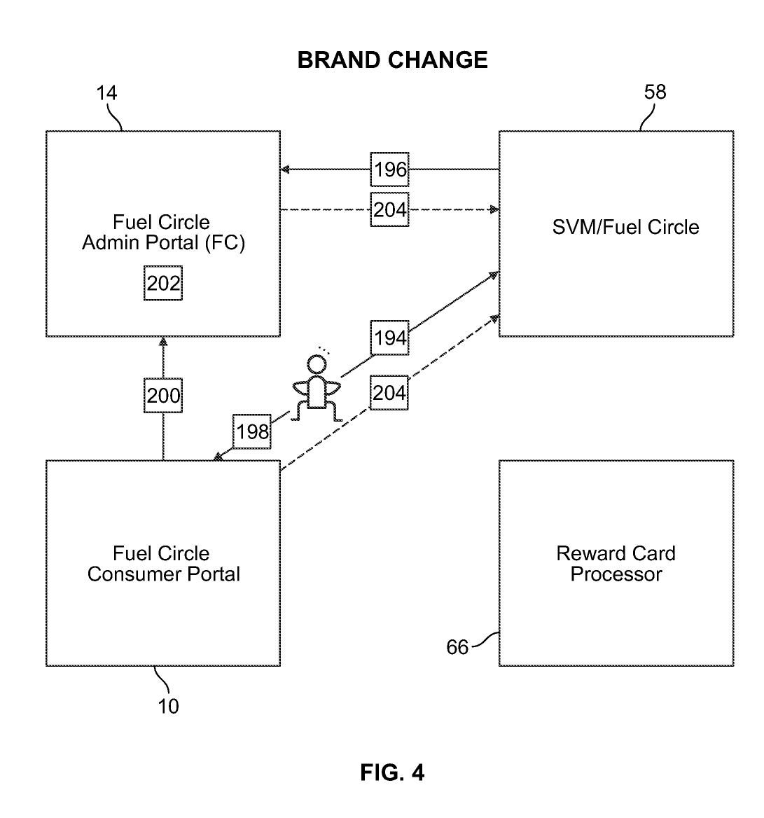

Members can call FuelCircle to change their preferred gasoline brand and request a new reward card for their new preferred gasoline brand. A flow diagram for changing the member's preferred brand is shown in FIG. 4. FuelCircle customer service 32 first verifies the member's identity by confirming email and responses to security questions 194, through the FuelCircle Processing system 14. FuelCircle customer service 32 updates the brand of the member's reward card 196 using the FuelCircle Processing system 14. Thereafter, the process is the same as for replacing a lost, stolen, or damaged rewards card.

The merchants also have an online merchant portal. Once the merchant logs in, the merchant can set promotional program parameters, access controls, and view reports. The promotional program parameters are qualifying purchases (item, basket, threshold, category, cross category, cross merchant, etc.), the number of points earned for each qualifying behavior, and the duration of the promotion. The merchant can force points to issue, through the access controls function, to address customer service and other issues. The merchant can view reports online and can export the reports, by promotion and by location and can also review points and charges.

The FuelCircle merchant portal provides for initial merchant setup, access controls, changes to merchant setup, customer service, and FuelCircle reporting and alerts. The FuelCircle reports and alerts display all activity for a specified period. In the period, the user can view programs and points activity in aggregate and by merchant. The program and points activity includes daily, or other time frames, points issuance, points charged to merchants, other fees charged to merchants, automated clearing house transactions, and automated clearing house returns. The reward activity includes new cards issued, in aggregate and by brand, and rewards card reloads, in aggregate and by brand.

The FuelCircle system may be set by the administrator to limit the number of points a merchant may issue in a given time frame. The purpose of this is to control FuelCircle's credit risk with each merchant. Once a merchant has exceeded their limit, the system will automatically shut off the merchant's ability to issue more points or will set off an alarm that requires manual action by FuelCircle personnel. Merchants who have not paid for the service or who are behind in payments will lose their ability to issue more points, until their account is up to date. Once these issues have been resolved, the system will restore the merchant's ability to issue points. Merchants can view their issued points, payment history, and current status via the merchant portal.

The reward and loyalty space system of the present invention recognizes qualifying purchases, via the POS system or with the merchant's in-store or e-commerce systems, and generates points in the consumer's account. Qualifying consumer behaviors are set up by the FuelCircle participating merchant. Each time a consumer makes a qualifying purchase or performs a qualifying behavior, the consumer will be given a receipt that includes point information, and in an alternate embodiment expiration information, on the tail of the receipt when their loyalty card is presented or an alternate form of identification, such as a phone number, is presented. While shopping in a store and purchasing its products or a certain brand of products is a common qualifying behavior, a purchase may not always be required to earn points. Merchants without a POS system will be more inclined to use the bulk points/codes method and service of issuing points to consumers, from FuelCircle or a loyalty currency aggregator, such as Points.com, and other loyalty currency aggregator's service. These merchants can go on the merchant portal or a loyalty currency aggregator, such as the Points.com website, which has a platform to generate unique codes representing a designated number of points. The merchants can receive these codes in a variety of forms, such as an Excel file, a printed certificate, or an email designated to recipients. Upon making a qualifying purchase, the merchant can then deliver a code to the consumer in a format of their choosing, such as scratch-off ticket. Qualifying behaviors that earn points through the codes can include test driving a certain make and model of vehicle during a specified period of time at a participating manufacturer dealer location or “liking” a brand or product on a company sponsored Facebook page. The consumer can then redeem the code online at FuelCircle.com or at the loyalty currency aggregator hosted website by entering the code, which will retrieve the point value of the code. FuelCircle or the loyalty currency aggregator website will then transmit the point value and the consumer's account ID to the system of the present invention, which will add that point value to the consumer's account. If the consumer does not have an existing reward and loyalty space system account, the consumer can follow a link on the loyalty currency aggregator code redemption website to the system's registration webpage to first register and set up an account on the FuelCircle website. The consumer can then complete their system registration and return to the loyalty currency aggregator website, with their new account ID, to redeem their code.

Merchants can also purchase these unique codes from FuelCircle directly, which handles the sales and distribution of the codes in any format the merchant desires. The reward and loyalty space system provides the platform for generating the codes, that represent a designated number of points, and delivers them to FuelCircle via an Excel file. As with a loyalty currency aggregator such as Points.com, the consumer can redeem the codes directly on the system's website. After signing in, or registering if not a current account holder, the consumer enters the code and the system validates the code and adds the associated point value to the consumer's account.

Merchants may also directly deposit points into a consumer's account. The merchant defines what qualifying purchase or qualifying behavior the consumer needs to perform in order to earn points. Once the consumer performs the qualifying behavior or makes the qualifying purchase, the merchant determines that the consumer has performed the qualifying behavior or purchase and determines how many points to allocate for that behavior. The merchant can then directly deposits the points earned by that behavior into the consumer's account via an advanced programming interface (API) or other connection to the FuelCircle system.

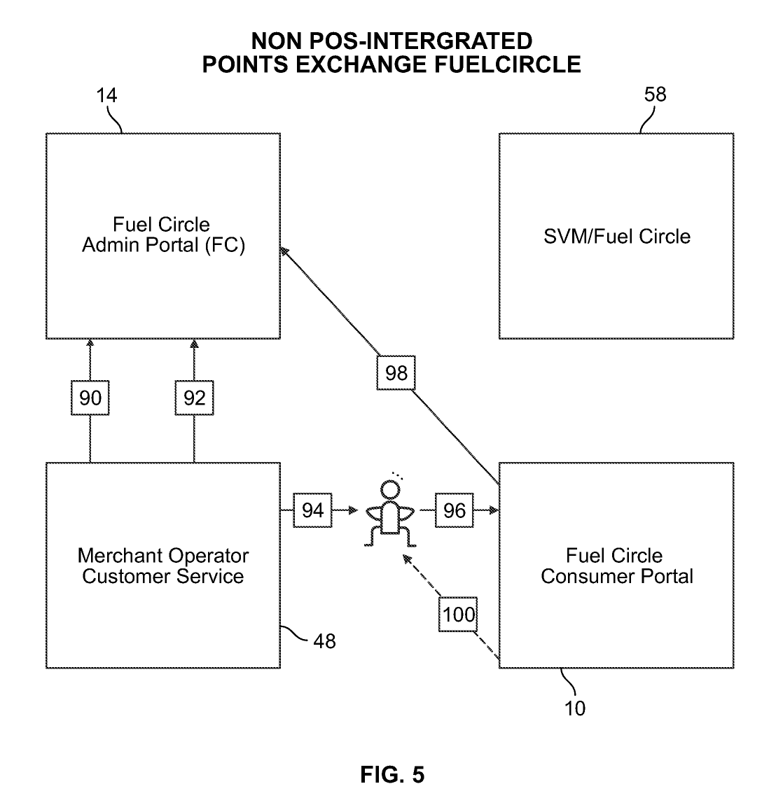

The flow diagram for non-POS-integrated points exchange (FuelCircle) is shown in FIG. 5. The merchant requests codes 90 via the FuelCircle Processing system 14 API and the FuelCircle Processing system 14 provides codes to the merchant as a bulk file download or as individual codes 92 via the API. The merchant then provides the codes to their program members via a distribution method of their choosing 94. The program member visits the FuelCircle consumer portal 10 and redeems their codes 96. If the program member is not a FuelCircle member they will be directed to the registration process before continuing. The consumer portal 10 uses the FuelCircle Processing system 14 API to validate codes, to ensure that the codes are not expired and have not already been redeemed, and deposits resulting points into the member's account 98. If the codes are not valid FuelCircle Processing system 14 codes, the FuelCircle Processing system 14 will pass appropriate messaging, indicating that the codes are expired or already redeemed, to the consumer portal 10 which will, in turn, provide an appropriate message to the member. The FuelCircle consumer portal 10 then sends the member a confirmation email upon successful redemption 100.

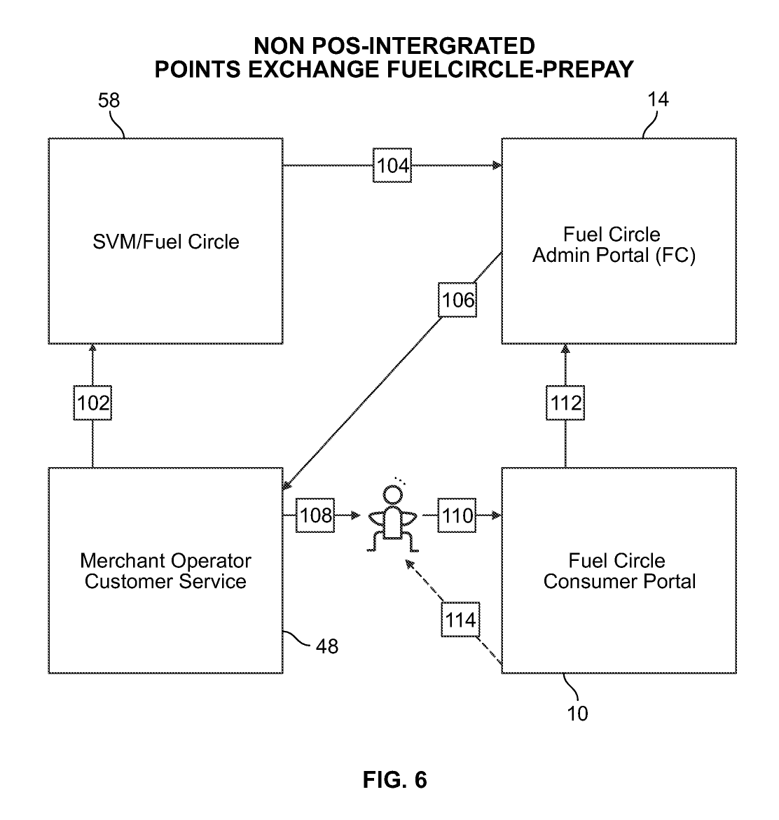

The flow diagram for non-POS-integrated points exchange (FuelCircle) prepay is shown in FIG. 6. The merchant requests prepay codes directly from FuelCircle 58 and makes a payment 102, which is handled by FuelCircle 58 outside of the FuelCircle Processing system 14. Funds from these prepay codes are deposited in a separate FuelCircle Points bank account. Upon request, the FuelCircle 58 administrator creates and releases the codes 104. The FuelCircle Processing system 14 then provides the codes to the merchant as a bulk file download or individual codes 106 via the API. The merchant then provides the codes to their program members via print or email 108. The program member visits the FuelCircle consumer portal 10 and redeems their codes 110. If the program member is not a FuelCircle member they will be directed to the registration process before continuing. The FuelCircle consumer portal 10 communicates with the FuelCircle Processing system 14 API to validate the codes, ensuring that the codes are not expired and not already redeemed, and deposits the points associated with each code in the member's account 112. If the codes are not valid, the FuelCircle Processing system 14 will pass an appropriate message, stating that the codes are expired or have already been redeemed, to the consumer portal 10, which will in turn provide an appropriate message to the member. The FuelCircle consumer portal 10 will then send the member a confirmation email upon successful redemption 114.

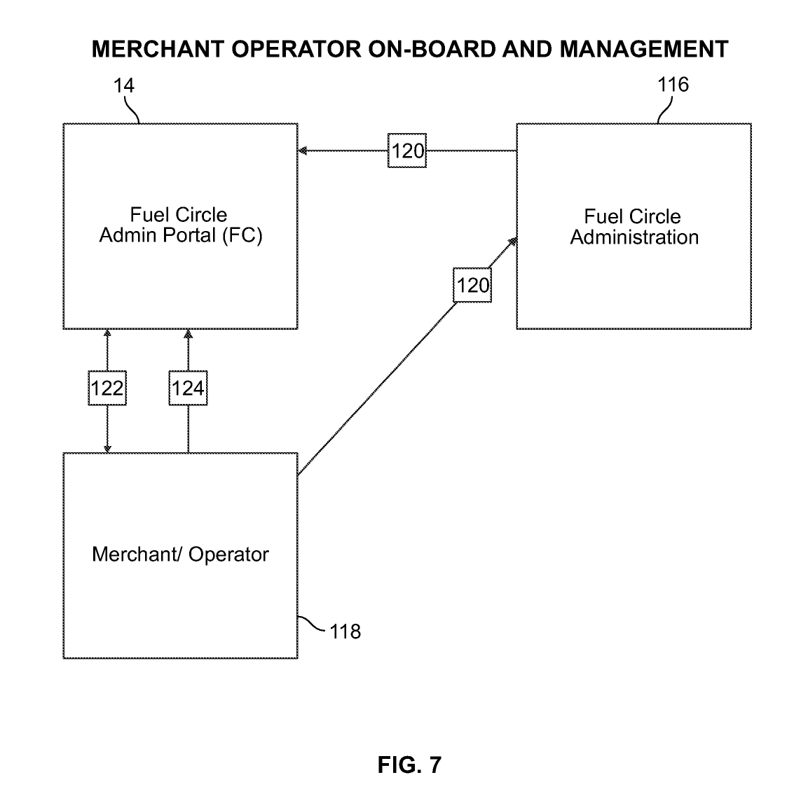

The flow diagram for merchant on-board and management is shown in FIG. 7. The FuelCircle administration 116 gathers details from the merchant 118 and completes initial on-board process 120 using the FuelCircle Processing system 14. The merchant 118 works with the FuelCircle Processing system 14 to establish a virtual private network (VPN) connection and automated clearing house (ACH) setup 122. The merchant 118 then completes registration 124 using the FuelCircle Processing system 14.

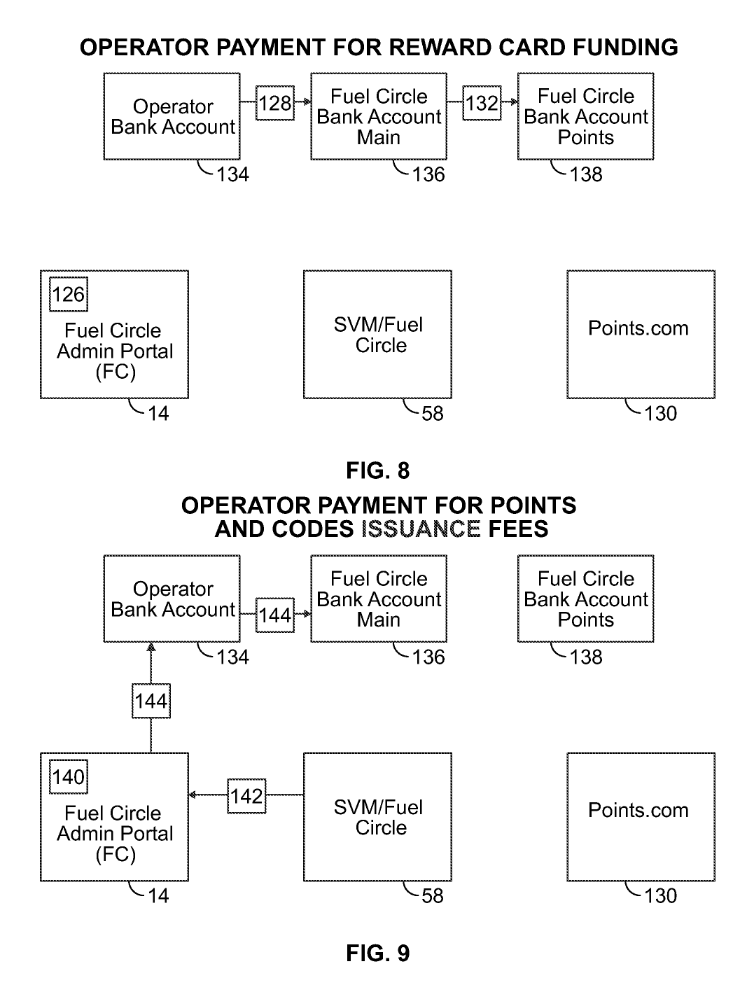

The flow diagram for operator payment for reward card funding is shown in FIG. 8. For reward card funding, the FuelCircle Processing system 14 calculates the merchant's 118 (FIG. 7) share of each initial load and reload 126 and then the FuelCircle Processing system 14 creates an ACH transaction to pull the corresponding funds 128 from the merchant's 118 bank account 134 into SVM's 58 main FuelCircle bank account 136. For reward card funding (prepay), for points generated from the FuelCircle Processing system 14 prepay codes, for the loyalty currency aggregator 130 codes, and for loyalty currency aggregator 130 trades or exchanges, SVM 58 FuelCircle will designate the SVM 58 points FuelCircle bank account 138, instead of an merchant 118 bank account 134. The FuelCircle Processing system 14 then creates an ACH transaction to pull the corresponding funds 132 from the SVM's 58 Points bank account 138 into SVM's 58 main FuelCircle bank account 136.

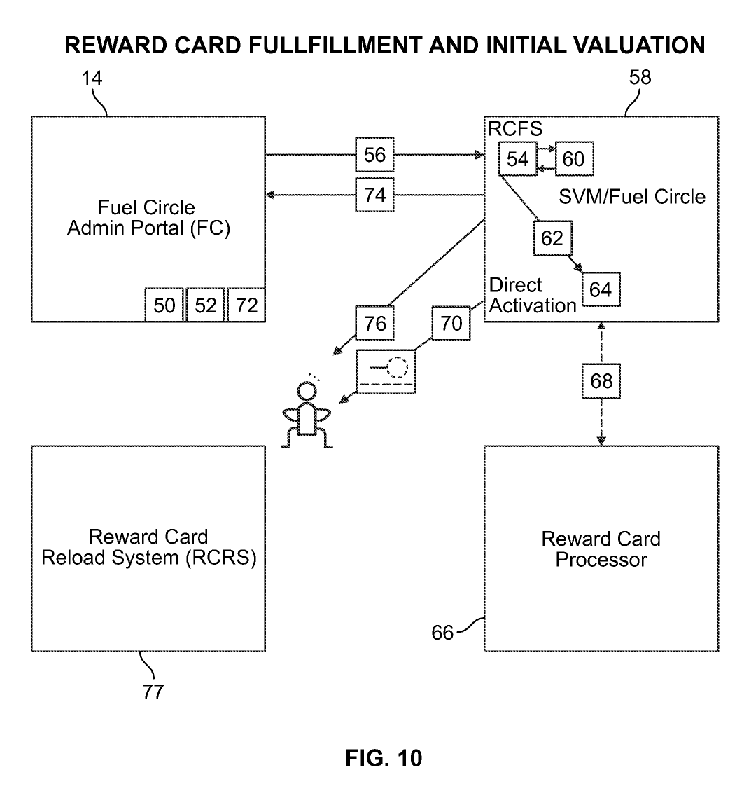

The flow diagram for operator payment for points and codes issuance fees is shown in FIG. 9. The FuelCircle Processing system 14 calculates and charges FuelCircle 58 for points issued and codes issued 140 by the merchant/operator 118. SVM 58 FuelCircle uses the FuelCircle Processing system 14 reporting to calculate each merchant's share of charges for issued points and issued codes 142. SVM 58 FuelCircle then charges operators 118 (FIG. 7), via manual FuelCircle ACH or other means 144. It is contemplated that SVM 58 will export the merchant charge data, update per SVM 58 tiered pricing and then import back into the ACH system to pull funds from operators 118.

In the illustrated embodiment, for every 2,550 points earned, $25.00 is loaded on the consumer's FuelCircle Rewards Card and the funds can be redeemed at the pump or in-store at an authorized FuelCircle redemption location. When 2,550 or more points are achieved, in increments of 2,550 points, a trigger event occurs and points are converted automatically to $25.00 and loaded to the consumer's FuelCircle Rewards Card in real time. This points threshold is the same for all points so that a point has a fixed conversion value to dollars on a card. However, it is possible that this conversion value could be modified from time to time. It is also possible that the points threshold for generating the funding of a reward card could be modified from time to time.

After the consumer has completed the registration process, including selecting their brand of choice for their FuelCircle Rewards Card, the consumer does not have to do anything to affect the conversion of points to dollars. When points are converted to funds, these points are allocated from and funded by the rewards issuers on a first in first out basis. The earliest points issued are the earliest points to be converted to funds on the consumer's FuelCircle Rewards Card, thereby tracking which reward issuers are funding the conversion of points into funds on the stored value cards.

The first time a consumer's account reaches the points threshold, the system sends a daily file with all reward cards to be activated to the reward card fulfillment system. The file includes each qualifying consumers' name and address, account ID, gasoline brand, and dollar amount to be loaded onto the reward card. FuelCircle then sends the loyalty processing system a shipping confirmation file with each consumer's account ID, sequence number and check digit of the rewards card sent to the consumer, and the initial value loaded on the rewards card. The reward amount is a predetermined fixed amount in relation to the points the consumer has earned, such as $25.00 for every 2,550 points earned. When the consumer earns subsequent rewards, FuelCircle will then send to the reward card system gateway the reward card sequence number and the dollar amount to be loaded. Upon receiving confirmation that the reward card was replenished, the system posts an entry to the consumer's account showing the $25 credit and the date it was made. The point conversion and reward issue automatically, and in real-time, without any further action required from either the consumer or the merchant. The FuelCircle Rewards Card can be used to purchase gas or other items at an authorized redemption location, such as the gasoline station chosen by the consumer upon registration. The FuelCircle Rewards Card can be used to purchase gas, drinks, snacks, and other items in the station or attached convenience store.

Points keep accumulating in the account as the consumer purchases qualifying products or takes other qualifying actions. Points are aggregated into a consumer's FuelCircle account across all participating rewards issuers. Once the consumer's account balance reaches a predetermined points threshold, such as 2,550 points, the points are converted and the consumer is issued a reward. The reward card fulfillment and initial valuation flow diagram is shown in FIG. 10. When a FuelCircle member's account balance first exceeds 2,550 points, the FuelCircle Processing system 14 includes a record for them in a daily fulfillment file 50. The initial load amount is in $25 increments, 2,550 points, up to a maximum reward card transaction amount, although this threshold could be varied in the future. The FuelCircle Processing system 14 sets the reward card status so no further funds are pushed until the card number is received 52. The reward card fulfillment system 54 pulls the daily fulfillment file 56, which contains the member name, address, email, SKU, and includes the reward card brand and reward amount, from the FuelCircle Processing system 14. FuelCircle fulfillment exports orders, batched by brand, as files from the reward card fulfillment system 54, card numbers are assigned and populated in the files, FuelCircle fulfillment uploads the files back into the reward card fulfillment system 54, and batch prints fulfillment letters 60. FuelCircle fulfillment exports card numbers to activate, by brand, from the reward card fulfillment system 54 into files which they upload 62 into the direct activation system 64. The direct activation system 64 sends the nightly batch file to the reward card processor 66 and receives acknowledgement the next day 68. FuelCircle fulfillment then ships the reward card to the FuelCircle member 70. The reward card fulfillment system 54 pushes the reward card numbers to the FuelCircle Processing system 14 via a daily tracking file, that contains the FCMID and reward card number, and the FuelCircle Processing system 14 sets the reward card number 74. The FuelCircle Processing system 14 then updates the reward card status so points can once again be pushed to dollars on the card 72. Once the reward has been fulfilled, the reward card fulfillment system 54 sends the member a confirmation email for the reward card fulfillment 76.

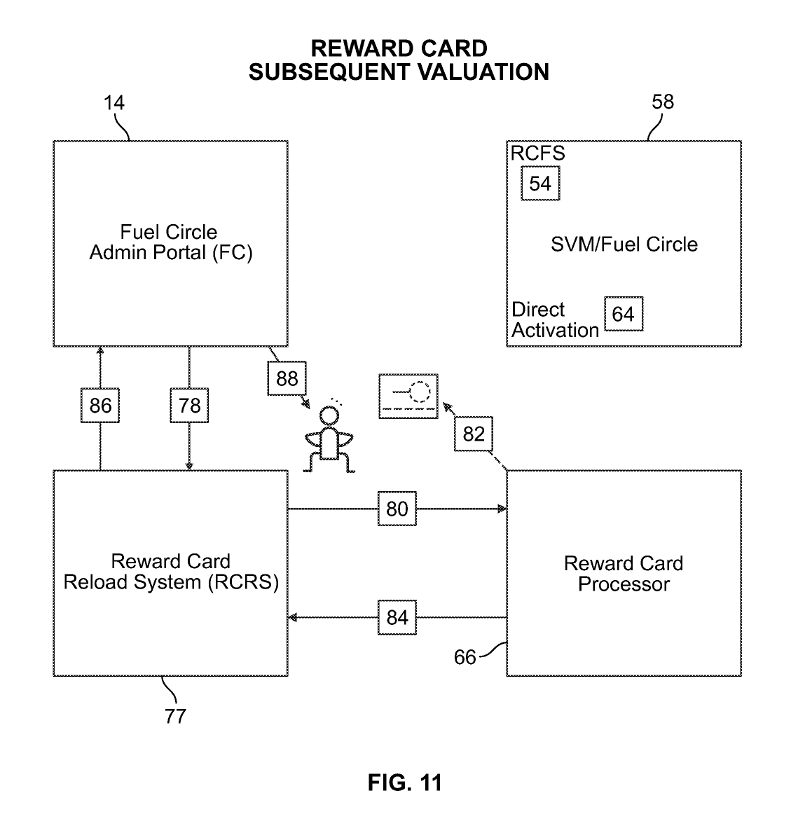

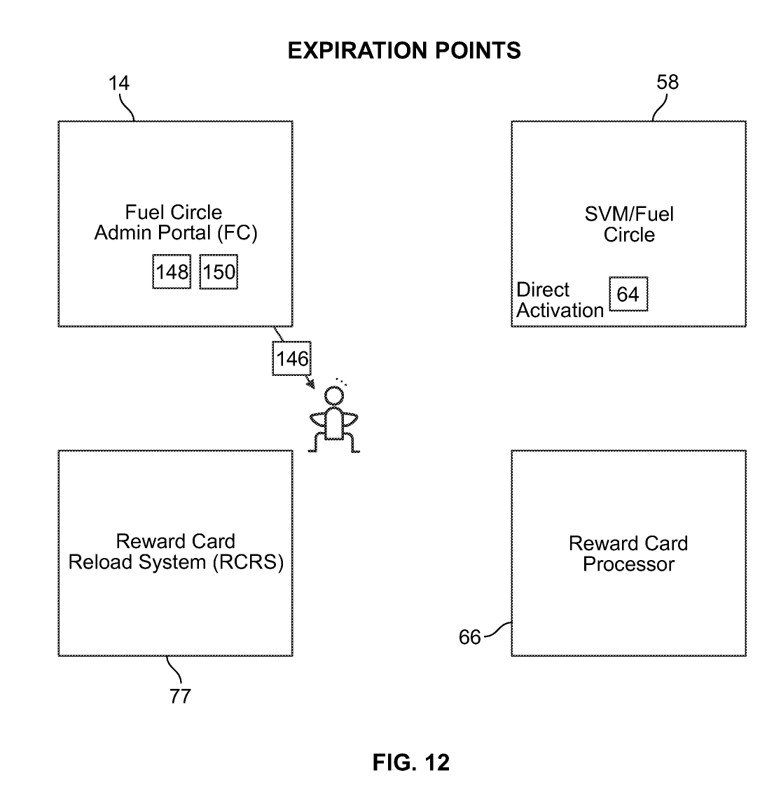

Subsequent valuation of an already issued reward card is shown in FIG. 11. When a FuelCircle member's account balance subsequently exceeds 2,550 points, the FuelCircle Processing system 14 adds value to the member's reward card through the reward card reload system 77 and the reload amount will initially be in $25 increments (2,550 points) up to the maximum reward card transaction amount. The FuelCircle Processing system 14 makes a request for card valuation via the reward card reload system 77 application programming interface (API) 78. The reward card reload system 77 requests valuation 80 from the reward card processor 66. The reward card processor 66 loads the value onto the member's reward card 82 and acknowledges the successful valuation 84. The reward card reload system 77 also acknowledges successful valuation 86 and the FuelCircle Processing system 14 sends the member a confirmation email for the reward card reload 88.

Funds on a rewards card expire twice a year, with a grace period for funds earned in the 90 days prior to the expiration date. The funds that were loaded in the 90 days prior to the expiration date will roll over and, if not used, expire on the following expiration date. The expiration dates are fixed, are six months apart and are the same for all rewards cards. The system will generate and send a marketing reminder and a proactive series of messages, via email or SMS messaging, to the consumer warning that the points and funds are soon to expire. FuelCircle determines which rewards card balances meet the expiration requirements, by performing inquiries on the reward card processing system, to get the balances of all rewards cards in the system and the total valuations on all FuelCircle member reward cards during the grace period. Shortly thereafter, FuelCircle executes the devaluation process via a batch file submitted to the reward card processing system. The system will post to the consumer's account that funds have expired and the value that was removed from the rewards card.

In an alternate embodiment, points may expire twice a year. A flow diagram for points expiration is shown in FIG. 12. Points may expire twice per year, on March 31^{st} and September 30^{th} for example, with a grace period for points earned in the 90 days prior to the expiration date. The FuelCircle Processing system 14 will send points expiration reminder email messages to members per configurable schedule 146. The FuelCircle Processing system 14 will execute the point expirations per pre-defined rules, as stated above 148. The FuelCircle Processing system 14 will then create a line item in the members' accounts noting the expiration event 150, which will also be visible to FuelCircle Customer Service 32.

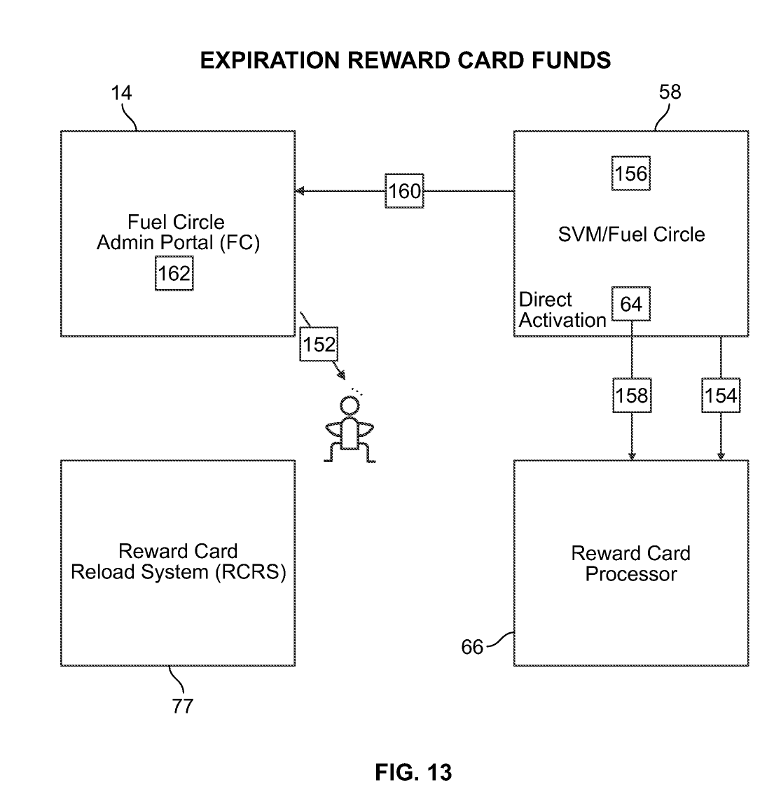

A flow diagram for reward card funds expiration is shown in FIG. 13. Funds will expire twice per year, on March 31^{st} and September 30^{th} for example, with a grace period for funds earned in the 90 days prior to the expiration date. The FuelCircle Processing system 14 will send funds expiration reminder email messages to members per configurable schedule 152. The same message will go to all members and will possibly exclude members that registered within the previous one or two months. FuelCircle queries the reward card processor 66 to capture the balance on all FuelCircle member reward cards and the total valuations on all FuelCircle member reward cards during the grace period 154. FuelCircle calculates which FuelCircle member reward cards need to be devalued and by how much 156. FuelCircle executes the devaluation 158 by batch file submitted to the reward card processor 66. FuelCircle then creates and pushes the tracking file to the FuelCircle Processing system 14 and communicates the funds expiration event using the reward card processor 66 confirmation file 160, which includes the file date, the reward card number, and the dollar amount of the funds removed. The FuelCircle Processing system 14 then creates a line item entry for the funds expiration event in the members' accounts for their impacted reward card 162.

Merchants only pay for the points issued by them that are converted to funds on the rewards cards based on a first in, first out basis. Merchants are also charged transaction fees and other fees. FuelCircle has the ability to set the minimum balance for a merchant's account and an automated clearing house debit transaction is triggered when the balance falls below this amount. Automated clearing house debits from the participating merchant's bank accounts are initiated each day to top off balances in the merchant's account to minimum levels. These deductions are directed into a single FuelCircle bank account. The merchant will lose its ability to issue points if an automated clearing house deduction is returned. A second automated clearing house debit transaction, including an added fee for the initial return, is attempted after a specified delay after the initial automated clearing house deduction is returned. The timing of this second debit transaction is based upon business rules designed to maximize the likelihood of collection. The automated clearing house functions and deductions also apply to bulk points merchants buying codes representing a certain value of points.

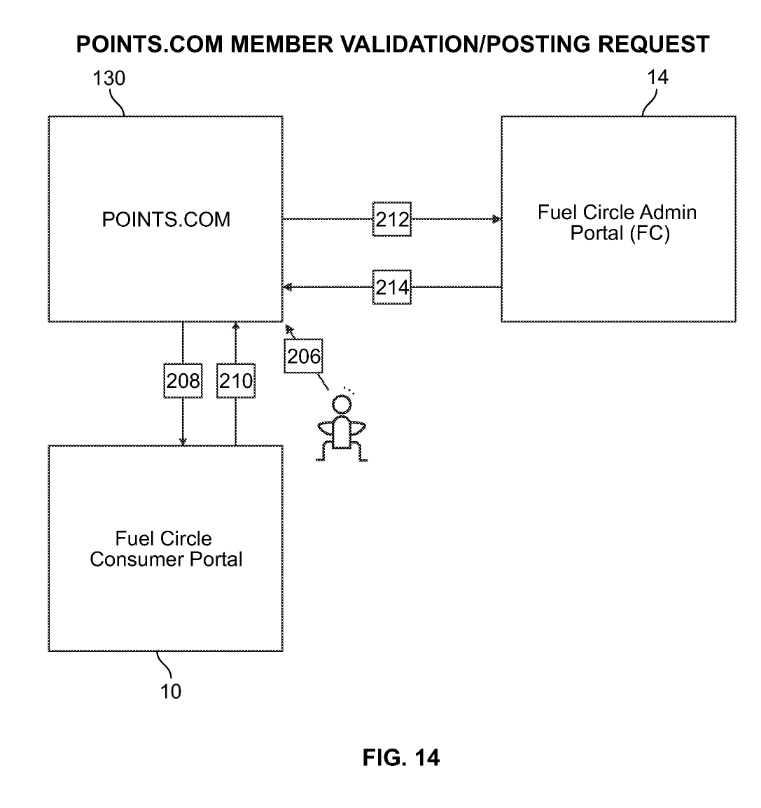

A flow diagram of the loyalty currency aggregator service's member validation and posting request is shown in FIG. 14. The FuelCircle member enters their credentials on the loyalty currency aggregator's www.points.com website (adding FuelCircle account, redeeming codes) 206. The loyalty currency aggregator's website verifies that it is a valid FuelCircle member account 208 by calling the FuelCircle consumer portal 10. If the credentials are valid, the FuelCircle consumer portal 10 returns the unique FuelCircle ID and other member data 210. The loyalty currency aggregator's website takes the member data and makes a posting request 212 to the FuelCircle Processing system 14. If successful, the FuelCircle Processing system 14 responds with posting details, if unsuccessful, the FuelCircle Processing system 14 responds with the appropriate error code(s) 214.

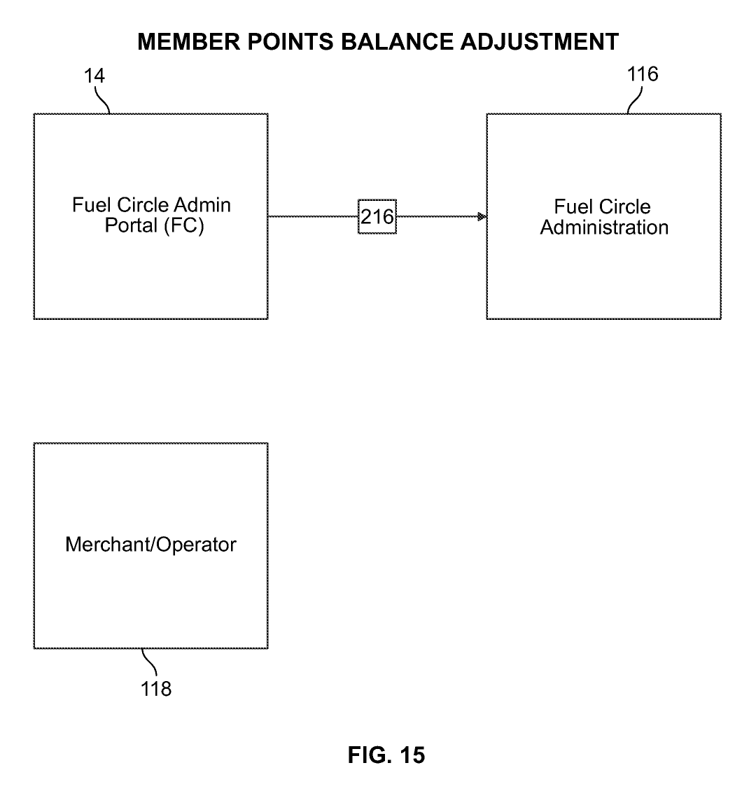

A flow diagram for member points balance adjustment is shown in FIG. 15. The FuelCircle Administrator 116, with sufficient authorization, uses the FuelCircle Processing system 14 to add points to the member account 216. FuelCircle “courtesy points” would come from a FuelCircle operator account set up in the FuelCircle Processing system 14 for this purpose. FuelCircle “courtesy points” that turn into dollars would be funded from the FuelCircle Points Bank Account. At the merchant's discretion, points could be added from their account as well.

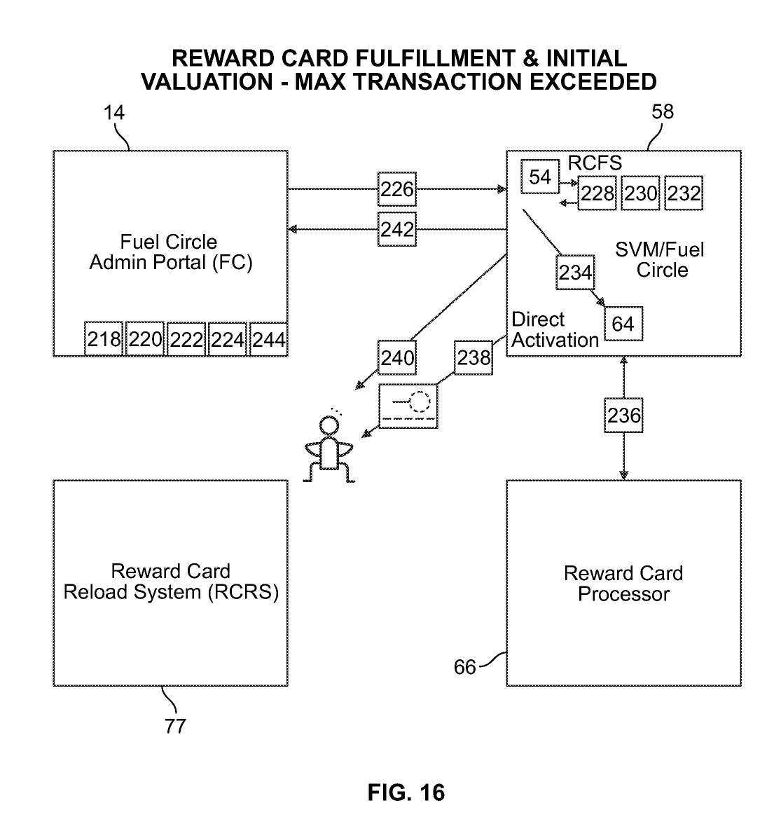

A flow diagram for reward card fulfillment and initial valuation—max transaction exceeded is shown in FIG. 16. A FuelCircle member's account balance first exceeds 2,550 points but the valuation amount will be in excess of the max reward card transaction value 218. The FuelCircle Processing system 14 removes the points from the member's account 220 and sets the reward card status to special “Max Value” status 222. The FuelCircle Processing system 14 includes a record for the member in the daily fulfillment file that includes the value that will be the full value and the SKU will be a special max-value SKU, one per brand 224. The FuelCircle fulfillment system 54 pulls the daily fulfillment file, which contains the member name, address, email address, and the SKU, that includes the reward card brand and the load amount, 226 from the FuelCircle Processing system 14. FuelCircle fulfillment calls up FuelCircle orders containing special Max Value SKUs and Fulfillment edits the order to show one $1000, or max value, reward card and one regular gift card for overage and the regular gift card number captured in notes 228. After integration, approximately the next day, the gift cards are moved from notes to a line item within the order for future search purposes 230. Reward cards are invoiced in the FuelCircle accounting system 232. FuelCircle fulfillment exports card numbers to activate, by brand, from the fulfillment processing system 54 into files which they upload 234 into the reward card activation system 64. The reward card activation system 64 sends the nightly batch file to the reward card processor 66 and receives acknowledgement the next day 236. FuelCircle fulfillment ships the reward card and custom letter 238, that was created in step 228. FuelCircle (FuelCircle reward card fulfillment 54) sends the member a confirmation email for reward card fulfillment 240. FuelCircle (FuelCircle reward card fulfillment 54) then pushes reward card numbers to the FuelCircle Processing system 14 via the daily tracking file, which includes the FCMID and reward card number, and then the FuelCircle Processing system 14 adds the reward card number to the consumer's account 242. The FuelCircle Processing system 14 then updates the reward card status so points can once again be pushed to dollars 244.

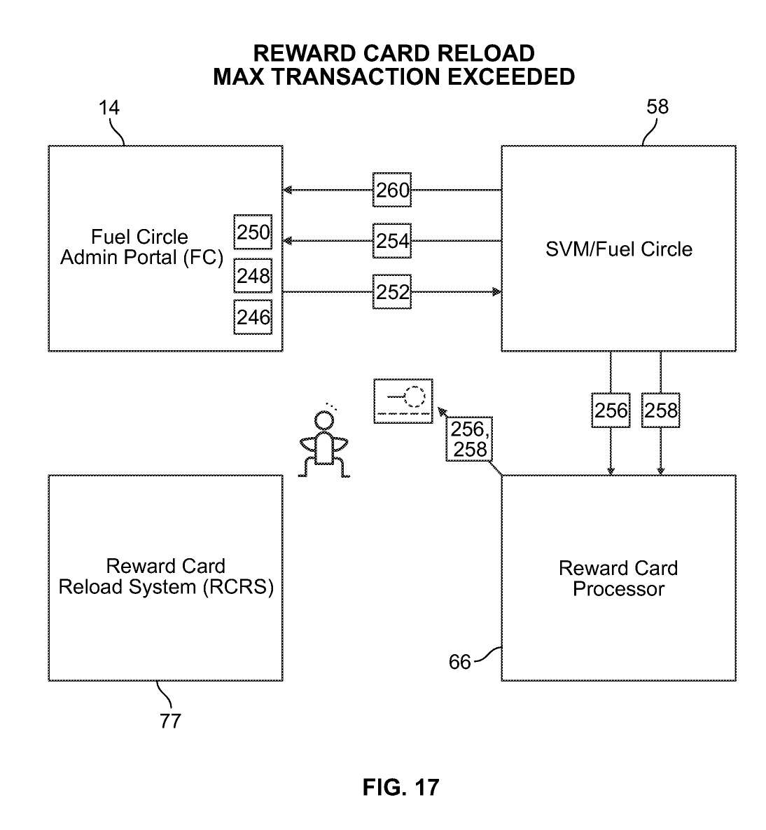

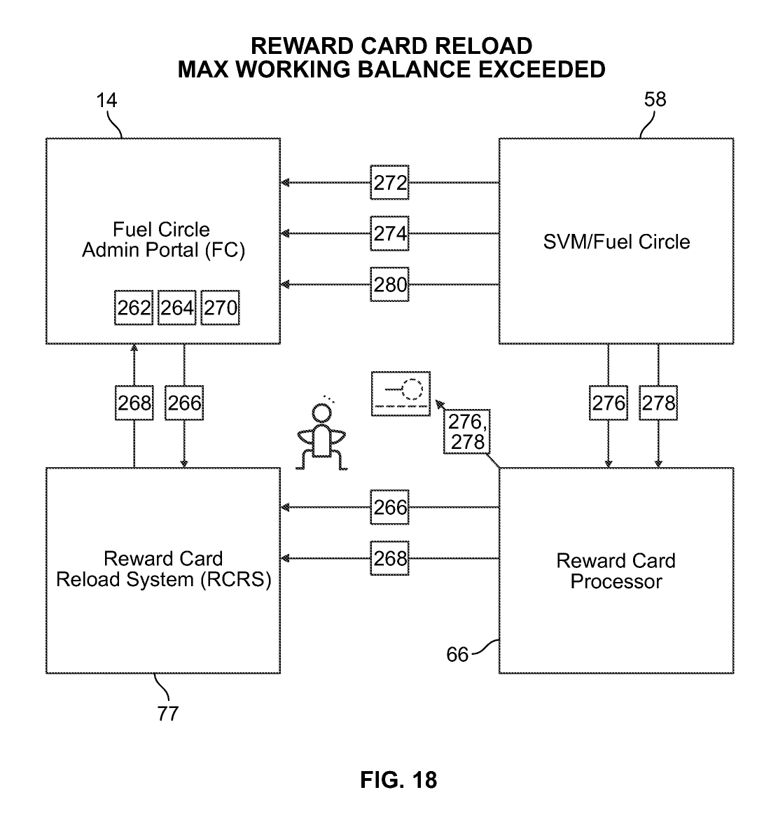

A flow diagram for reward card reload—max transaction exceeded is shown in FIG. 17. The member has enough points to result in a reload, but valuation amount will be in excess of the maximum reward card transaction value 246. The FuelCircle Processing system 14 removes the points from the member's account 248 and changes the reward card status to “Max Value” 250. FuelCircle Administrator reviews reward cards in Max Value status in the FuelCircle Processing system 14 via a daily report or exception screen 252. FuelCircle administrator can review member accounts and points removed that would have resulted in a max transaction situation 254. FuelCircle Administrator manually adds value to the member's reward card using the reward card processing system portal up to the maximum transaction amount 256. As working balance space becomes available FuelCircle Administrator manually releases funds to member's reward card via the reward card processing system 258, which can be an ongoing, manual process. When the member's reward card again has working balance room, the FuelCircle Administrator changes the reward card status to active 260.

A flow diagram for reward card reload—max working balance exceeded is shown in FIG. 18. A FuelCircle member's account balance exceeds 2,550 points 262. The FuelCircle Processing system 14 removes the points from the member's account 264 and makes a request for card valuation 266 via the reward card reload system 77 API to the reward card processor 66. The reward card reload system 77 requests valuation 268, which fails with a reward card processor 66 error message of 14. The FuelCircle Processing system 14 changes the reward card status to “Max Value” 270. FuelCircle Administrator reviews reward cards in Max Value status in the FuelCircle Processing system 14 via a daily report or exception screen 272. FuelCircle Administrator can review member accounts and points removed that would have resulted in a maximum balance situation 274. FuelCircle Administrator manually adds value to the member's reward card using the reward card processing system up to the maximum transaction amount 276. As working balance space becomes available, FuelCircle Administrator manually releases funds to member's reward card via the reward card processor 278, which can be an ongoing, manual process. When the member's reward card again has working balance room, the FuelCircle Administrator changes the reward card status to active 280.

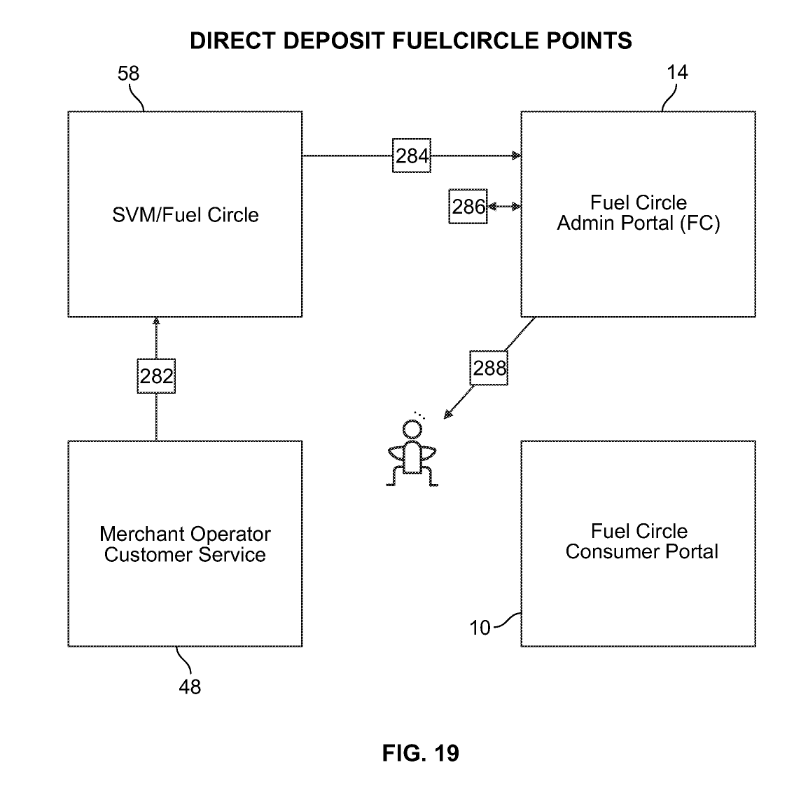

A flow diagram for direct deposit FuelCircle points is shown in FIG. 19. The merchant 48 requests the direct deposit of points from FuelCircle 58. The merchant is charged for points once they convert to funds on a reward card on a first in first out basis just like any other merchant 282. The direct deposit request must include the FuelCircle member numbers for deposits. In certain cases, the points may be prepaid and the funds from prepay points will be deposited in a separate FuelCircle Points bank account. In these cases, upon receipt of the funds, FuelCircle 58 then creates or releases the points 284. The FuelCircle Processing system 14 deposits the points in the member accounts 286 and then sends an email confirmation to the member 288.

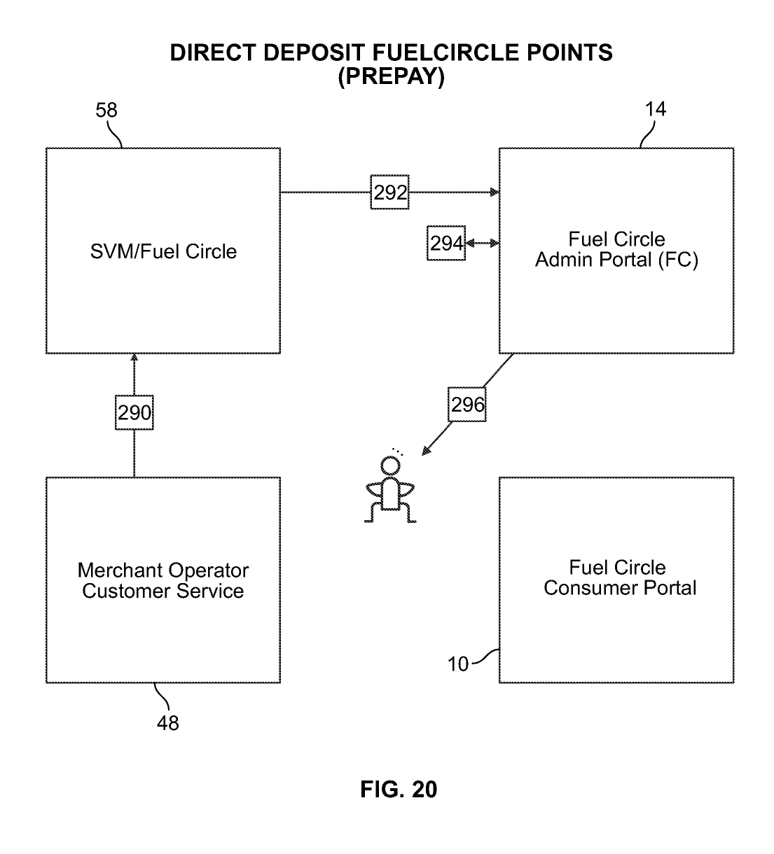

A flow diagram for direct deposit FuelCircle points (prepay) is shown in FIG. 20. The merchant 48 requests the direct deposit of points from FuelCircle 58 and makes a payment 290. FuelCircle invoices the merchant and receives payment outside of the FuelCircle loyalty processing and merchant ACH system. The request must include the FuelCircle member numbers for deposits and the funds from prepay points will be deposited in a separate FuelCircle Points bank account. FuelCircle 58 then creates or releases the points 292. The FuelCircle Processing system 14 deposits the points in the member's account 294 and then sends an email confirmation to the member 296.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for operating a fuel-based consumer reward and loyalty space program comprising the steps of:
a. receiving an account identifier;
b. detecting a qualifying purchase or other qualifying behavior;
c. receiving a total amount spent on the qualifying purchase or other data relating to the qualifying behavior;
d. determining whether the purchase or other behavior qualifies to earn points and appropriate earned point value;
e. adding the earned point value to a point total for the account corresponding to the account identifier stored in a database;
f. comparing the point total for the account corresponding to the account identifier stored in the database to a predetermined point balance threshold;
g. providing a predetermined monetary unit reward to an individual associated with the account corresponding to the account identifier if the point total for the account corresponding to the account identifier stored in the database is at least the predetermined point balance threshold; and
h. deducting the predetermined point balance from the point total in the corresponding account number stored in the database.

2. The method of claim 1, wherein receiving an account identifier further includes the steps of:
a. receiving personal information;
b. receiving security questions;
c. receiving answers to said security questions;
d. receiving a fuel brand;
e. receiving terms, conditions, and privacy policy;
f. receiving a password;
g. calling a FuelCircle system to create said account identifier;
h. receiving the account identifier;
i. calling the FuelCircle system to create a reward card number associated with said account identifier and a selected fuel brand;
j. receiving confirmation from the FuelCircle system; and
k. notifying the individual associated with said reward card number.

3. The method of claim 1, wherein providing a predetermined monetary unit reward further includes the steps of:
a. including a record in a daily fulfillment file for the account identifier associated with a point total that is at least the predetermined point balance;
b. setting a reward card status to not receive funds for said account identifiers;
c. retrieving the daily fulfillment file;
d. printing fulfillment letters;
e. exporting account identifiers to activate into activation files;
f. assigning a reward card number to the account identifiers in the activation files;
g. uploading the activation files every twenty-four hours;
h. receiving acknowledgement that the activation files were uploaded;
i. shipping the reward card to the individual associated with the account identifier;
j. sending the reward card numbers in a daily tracking file to a FuelCircle system;
k. setting the reward card status to receive funds;
l. setting the reward card number; and
m. notifying the individual associated with the reward card number.

4. The method of claim 3, wherein the daily fulfillment file includes the individual's name, address, email, reward card brand, and load amount.

5. The method of claim 3, wherein the daily tracking file includes the account identifier and the reward card number.

6. The method of claim 1, wherein providing a predetermined monetary unit reward further includes the steps of:
a. requesting a reward card valuation;
b. loading the predetermined monetary unit reward onto the reward card;
c. acknowledging successful valuation; and
d. notifying the individual of the valuation.

7. A method for operating a fuel-based consumer reward and loyalty space program comprising the steps of:
a. generating a code representing a predetermined point value;
b. delivering the code to a consumer;
c. receiving an account identifier;
d. receiving a code;
e. validating the code via a FuelCircle system;
f. receiving a point value associated with the code;
g. adding the point value to a point total for the account corresponding to the account identifier stored in a database;
h. comparing the point total for the account corresponding to the account identifier stored in the database to a predetermined point balance;
i. providing a predetermined monetary unit reward to a consumer associated with the account corresponding to the account identifier if the point total for the account corresponding to the account identifier stored in the database is at least the predetermined point balance; and
j. deducting the predetermined point balance from the point total in the account corresponding to the account identifier stored in the database.

8. The method of claim 1, wherein points in the point total expire twice per year.

9. The method of claim 8, wherein points in the point total earned within the ninety days prior to the expiration date do not expire.

10. The method of claim 8, wherein points that expire on the expiration date are deducted from the point total in the account corresponding to the account identifier.

11. The method of claim 1, wherein the reward card funds expire twice per year.

12. The method of claim 11, wherein funds on the reward card earned within the ninety days prior to the expiration date do not expire.

13. The method of claim 11, wherein the funds that expire on the expiration date are deducted from the funds on the reward card for the account corresponding to the account identifier.

14. The method of claim 7, wherein the codes expire seven months after being generated.

15. The method of claim 7, wherein points in the point total expire twice per year on an expiration date.

16. The method of claim 15, wherein points in the point total earned within the ninety days prior to the expiration date do not expire.

17. The method of claim 15, wherein points that expire on the expiration date are deducted from the point total in the account corresponding to the account identifier.

18. The method of claim 7, wherein the reward card funds expire twice per year on an expiration date.

19. The method of claim 18, wherein funds on the reward card earned within the ninety days prior to the expiration date do not expire.

20. The method of claim 18, wherein the funds that expire on the expiration date are deducted from the funds on the reward card for the account corresponding to the account identifier.

21. The method of claim 1, wherein the predetermined monetary unit reward is associated with a fuel brand of the individual's preference.

22. A system comprising a computer readable medium having stored thereon computer executable instructions for implementing a method comprising:
a. receiving an account identifier;
b. detecting a qualifying purchase or other qualifying behavior;
c. receiving a total amount spent on the qualifying purchase or data relating to the qualifying behavior;
d. determining whether the purchase or other behavior qualifies to earn points and an appropriate earned point value;
e. adding the total amount of the earned point value to a point total for the account corresponding to the account identifier stored in a database;
f. comparing the point total for the account corresponding to the account identifier stored in the database to a predetermined point balance;
g. providing a predetermined monetary unit reward to an individual associated with the account corresponding to the account identifier if the point total for the account corresponding to the account identifier stored in the database is at least the predetermined point balance; and
h. deducting the predetermined point balance from the point total in the account corresponding to the account identifier stored in the database.

23. The system of claim 22, wherein receiving an account identifier further includes the steps of:
a. receiving personal information;
b. receiving security questions;
c. receiving answers to said security questions;
d. receiving a fuel brand;
e. receiving a password;
f. calling a FuelCircle system to create said account identifier;
g. receiving the account identifier;
h. calling the FuelCircle system to create a reward card number associated with said account identifier and a selected fuel brand;
i. receiving confirmation from the FuelCircle system; and
j. notifying the individual associated with said reward card number.

24. The system of claim 22, wherein providing a predetermined monetary unit reward further includes the steps of:
a. including a record in a daily fulfillment file for the account identifiers associated with a point total that is at least the predetermined point balance;
b. setting a reward card status to not receive funds for said account identifiers;
c. retrieving the daily fulfillment file;
d. printing fulfillment letters;
e. exporting account numbers to activate into activation files;
f. assigning a reward card number to the account identifiers in the activation files;
g. uploading the activation files every twenty-four hours;
h. receiving acknowledgement that the activation files were uploaded;
i. shipping the reward card to the individual associated with the account identifiers;
j. setting the reward card status to receive funds;
k. sending the reward card numbers in a daily tracking file to the FuelCircle system;
l. setting the reward card number; and
m. notifying the individual associated with the reward card number.

25. The system of claim 24, wherein the daily fulfillment file includes the individual's name, address, email, reward card brand, and load amount.

26. The system of claim 24, wherein the daily tracking file includes the account identifier and the reward card number.

27. The system of claim 22, wherein providing a predetermined monetary unit reward further includes the steps of:
a. requesting a reward card valuation;
b. loading the predetermined dollar reward onto the reward card;
c. acknowledging successful valuation; and
d. notifying the individual of the valuation.

28. A system comprising a computer readable medium having stored thereon computer executable instructions for implementing a method comprising:
a. generating a code representing a predetermined point value;
b. delivering the code to a consumer;
c. receiving an account identifier;
d. receiving a code;
e. validating the code via a FuelCircle system;
f. receiving a point value associated with the code;
g. adding the point value to a point total for the account corresponding to the account identifier stored in a database;
h. comparing the point total for the account corresponding to the account number stored in the database to a predetermined point balance;
i. providing a predetermined dollar reward to a consumer associated with the account corresponding to the account identifier if the point total for the account corresponding to the account identifier stored in the database is at least the predetermined point balance; and
j. deducting the predetermined point balance from the point total in the account corresponding to the account identifier stored in the database.

29. The system of claim 22, wherein points in the point total expire twice per year on an expiration date.

30. The system of claim 29, wherein points in the point total earned within the ninety days prior to the expiration date do not expire.

31. The system of claim 29, wherein points that expire on the expiration date are deducted from the point total in the account corresponding to the account identifier.

32. The system of claim 22, wherein the reward card funds expire twice per year on an expiration date.

33. The system of claim 32, wherein funds on the reward card earned within the ninety days prior to the expiration date do not expire.

34. The system of claim 32, wherein the funds that expire on the expiration date are deducted from the funds on the reward card for the account corresponding to the account identifier.

35. The system of claim 28, wherein the codes expire seven months after being generated.

36. The system of claim 28, wherein points in the point total expire twice per year on an expiration date.

37. The system of claim 36, wherein points in the point total earned within the ninety days prior to the expiration date do not expire.

38. The system of claim 36, wherein points that expire on the expiration date are deducted from the point total in the account corresponding to the account identifier.

39. The system of claim 28, wherein the reward card funds expire twice per year on an expiration date.

40. The system of claim 39, wherein funds on the reward card earned within the ninety days prior to the expiration date do not expire.

41. The system of claim 39, wherein the funds that expire on the expiration date are deducted from the funds on the reward card for the account corresponding to the account identifier.

42. The system of claim 22, wherein the predetermined monetary unit reward is associated with a fuel brand of the individual's preference.

43. The system of claim 28, wherein the predetermined monetary unit reward is associated with a fuel brand of the individual's preference.

44. The method of claim 7, wherein the predetermined monetary unit reward is associated with a fuel brand of the individual's preference.

45. A method for operating a fuel-based consumer reward and loyalty space program comprising the steps of:
a. receiving an account identifier;
b. receiving a total earned point value earned by a consumer to be added to the consumer's account;
c. adding the earned point value to a point total for the account corresponding to the account identifier stored in a database;
d. comparing the point total for the account corresponding to the account identifier stored in the database to a predetermined point balance threshold;
e. providing a predetermined monetary unit reward to an individual associated with the account corresponding to the account identifier if the point total for the account corresponding to the account identifier stored in the database is at least the predetermined point balance threshold; and
f. deducting the predetermined point balance from the point total in the account corresponding to the account identifier stored in the database.

46. The method of claim 1, wherein the qualifying transactions or other qualifying behaviors occur at locations of multiple unaffiliated merchants.

47. The method of claim 1, wherein the reward card is redeemable at multiple unaffiliated fuel brand facilities.

48. The method of claim 47, wherein the reward card is processed over an existing credit card, debit card, gift card, stored value, proprietary or other payment network.

49. The method of claim 47, wherein the reward card is authorized for the consumer's then current reward card balance without requiring a minimum authorization value.

50. The method of claim 1, wherein a merchant is charged for points relating to the individual's qualifying transactions or other behaviors when the monetary value is loaded to the individual's reward card.

51. The method of claim 50, wherein multiple merchants are charged for points based on a first in first out basis.

52. The method of claim 1, wherein a merchant prepays for points relating to qualifying transactions or other behaviors.

53. The method of claim 45, wherein the merchant qualifies the individual's transaction or behavior and then submits the point value earned directly to a computer based platform upon which the method is performed.

54. The method of claim 53, wherein the merchant submits the merchant's own account number or other identifier to the computer based platform and the computer based platform crosslinks the merchant's account number or other qualifier to the computer based platform's master account number for the individual.

55. The method of claim 53, where the individual identifies an existing loyalty or other program to the computer based platform and crosslinks that program to the individual's computer based platform's account.

56. The method of claim 1, wherein a merchant determines the earned point value to be earned by an individual for a qualifying purchase or other qualifying behavior.

57. The method of claim 56, wherein the earned point value earned by the individual has a fixed conversion rate to a monetary value to be added to a reward card.

58. The method of claim 1, wherein an individual can obtain additional points by purchasing the additional points for monetary value or by exchanging points previously earned by the individual in another loyalty program.

59. The method of claim 1, wherein an individual can sell points for monetary value or exchange points for points in another loyalty program.

60. The method of claim 1, where the individual identifies an existing loyalty or other program to the computer based platform and crosslinks that program to the individual's computer based platform's account.
